(19) United States
(12) Patent Application Publication
(10) Pub. No.: US 2015/0275326 A1
(43) Pub. Date: Oct. 1, 2015

(54) PREHEATING AND ANNEALING OF COLD ROLLED METAL STRIP

(71) Applicant: LINDE AKTIENGESELLSCHAFT, München (DE)

(72) Inventors: Henrik Gripenberg, Taby (SE); Johannes Lodin, Alvsjo (SE)

(21) Appl. No.: 14/431,624

(22) PCT Filed: Oct. 5, 2013
(86) PCT No.: PCT/EP2013/070754

§ 371 Date: Mar. 26, 2015

Related U.S. Application Data
(60) Provisional application No. 61/710,098, filed on Oct. 5, 2012.

(51) Int. Cl. C21D 9/56; C21D 1/52; C22F 1/04; C22F 1/08; F27D 13/00; C22C 21/00; C22C 38/00; F27B 9/28; F27B 9/36; F27D 9/00; C21D 9/52; C22C 9/00

(52) U.S. Cl. CPC C21D 9/56; C21D 9/52; C21D 9/563; C21D 1/52; C22F 1/04; C22F 1/08; C22C 9/00; C22C 21/00; C22C 38/00; F27B 9/28; F27B 9/36; F27D 9/00; F27D 13/00; F27B 2009/3615

(57) ABSTRACT

A method of continuously annealing a cold rolled metal strip, by continuously transporting the strip along a transport path where a ramp of direct flame impingement (DFI) burners are located for heating the strip. The ramp is located perpendicular, or substantially perpendicular, to the direction of movement of the strip and the DFI burners are mutually located such that the whole width of the strip is heated to the same, or substantially the same, temperature. The velocity of the strip on the transport path passing the ramp and the heating power of the DFI burners is adapted to heat the strip to annealing temperature, and the preheated strip is annealed in a continuous soaking furnace or annealing furnace.

### TECHNICAL FIELD OF THE PRESENT INVENTION

The present invention relates to the technical field of preheating and/or annealing cold rolled metal strips, in particular of preheating and continuously annealing cold rolled metal strips, such as aluminum strips.

### BACKGROUND OF THE PRESENT INVENTION

It is state of the art to anneal cold rolled aluminum strips at 250° C. to 500° C. The purpose is to restore good formability.

The mechanisms are removal of dislocation pile-ups (partial annealing) and recrystallization (annealing).

The recrystallization process is among others depending on time and on temperature. For example at 500° C. recrystallization takes a few seconds, at 380° C. a few minutes and at 280° C. a few hours. Other factors are alloy composition and the amount of cold work prior to the annealing.

The partial annealing takes place at 200° C. to 300° C. for prolonged times up to fifteen hours.

For aluminum strip coils a car bottom box furnace is normally used. The furnace is either heated by electrical elements or by fuel heated elements. To get good convection and temperature homogeneity in the furnace powerful fans are used to circulate the furnace atmosphere. The car bottom box furnace represents a significant investment.

The direct flame impingement (DFI) technique, where multiple oxyfuel burner flames directly hit and heat a moving steel strip is a technology previously developed. DFI burners are normally fed with fuel and an oxidant having a high oxygen content. It is preferred to use an oxidant having at least eighty percent by weight oxygen. Using DFI burners provides a high heat transfer from the flame to the steel strip and thus a very high heating rate.

However, DFI burners when fired with an oxidant with a high oxygen content, give a very high output power and a high flame temperature, such as 2.500° C.

In spite of this fact it has surprisingly been found out that it is possible to heat an aluminum strip very fast to a desired temperature without suffering from surface damages such as local melting on the surface of the strip. Aluminum has a melting point of approximately 660° C.

There is a problem with annealing according to prior art. Prior art coil annealing is a slow process. It is characterized by inefficient heating and low thermal conductivity between the layers of aluminum strip within the coil. This leads to long process times, low productivity and high energy consumptions.

A second problem is the risk of explosions from evaporated lubricants from the surface of the coiled material igniting with air inside the furnace.

A third problem is discolorations on the strip surface owing to reactions between the rolling lubricant, the metal and the atmosphere.

A fourth problem is that a long process time can cause a growth of the oxide layer on the strip surface leading to reduced soldering properties and other negative effects.

A fifth problem is that temperature gradients arise within the coil during the heat treatment. In partial annealing of coils there is a risk that the outer layers of the coil are heat treated at a different time temperature profile than the inner layers and this could lead to variations in mechanical properties.

### DISCLOSURE OF THE PRESENT INVENTION: OBJECT, SOLUTION, ADVANTAGES

Starting from the disadvantages and shortcomings as described above and taking the prior art as discussed into account, an object of the present invention is to overcome the above-mentioned problems that earlier methods have experienced.

This object is accomplished by a method comprising the features of claim 1 as well as by a method comprising the features of claim 14. Advantageous embodiments and expedient improvements of the present invention are disclosed in the respective dependent claims.

The present invention thus refers to a method of preheating a cold rolled metal strip prior to annealing, and is characterized in that the strip is continuously transported along a transport path where a ramp of direct flame impingement (DFI) burners are located, for heating the strip, in that said ramp is located perpendicular, or substantially perpendicular, to the direction of movement of the strip, in that the DFI burners are mutually located such that the whole width of the strip is heated to the same, or substantially the same, temperature, and in that the velocity of the strip passing the said ramp and the heating power of said burners are adapted to heat the strip to annealing temperature.

The present invention further refers to a method for annealing a cold rolled metal strip, and is characterized in that the strip is continuously transported along a transport path where a ramp of direct flame impingement (DFI) burners are located, for heating the strip, in that said ramp is located perpendicular, or substantially perpendicular, to the direction of movement of the strip, in that the DFI burners are mutually located such that the whole width of the strip is heated to the same, or substantially the same, temperature, in that the velocity of the strip passing the said ramp and the heating power of said burners are adapted to heat treat the strip such that annealing of the strip is carried out, in particular in a continuous soaking furnace or annealing furnace. The heat treated strip may be wound to a coil. The heat treated and coiled strip may be placed in the soaking furnace for partial annealing, in particular for removing dislocations.

According to an advantageous embodiment of the present invention, there may be
at least one ramp of DFI burners above said transport path of said strip, and
at least one ramp of DFI burners below said transport path of said strip in order to uniformly preheat said strip.

According to an expedient embodiment of the present invention, there may be two or more successive ramps of DFI burners located after each other along the transportation path in order to enhance the process of preheating said strip.

According to a favoured embodiment of the present invention, the DFI burners may be located in a furnace, in particular in a direct flame impingement (DFI) furnace. In this context or independently thereof, the ramp or ramps of DFI burners may be located in a furnace, in particular in a direct flame impingement (DFI) furnace.

According to a preferred embodiment of the present invention, the cold rolled strip may be unwound from a coil, in particular from a cold coil.

According to an advantageous embodiment of the present invention, the strip may be provided directly from a rolling stand to said transportation path. A safety wall may be located between the DFI furnace and the rolling stand because lubricants used when rolling may be flammable.

According to an expedient embodiment of the present invention, the strip to be annealed may be pre-heated by direct flame impingement (DFI). This provides several advantages. One advantage is that the length of the annealing furnace can be significantly reduced. By pre-heating the strip using DFI it is possible to heat the strip from room temperature to annealing temperature, i.e. to a temperature of about 450° C. to about 600° C., for example to a temperature of about 540° C., in a few seconds or less, in particular in about one second.

While the present invention may be favourably used with respect to the processing of aluminum strips, the present invention may be equally applicable to other metals, for example to copper, to iron, and to alloys of aluminum, copper and/or iron.

The present invention may be preferably used for strips having a thickness between 0.5 mm to a maximum thickness at which the strip can be coiled; in particular, the strip may comprise a thickness of about 0.9 mm to about 1 mm.

### BRIEF DESCRIPTION OF THE DRAWINGS

For a more complete understanding of the present inventive embodiment disclosures and as already discussed above, there are several options to embody as well as to improve the teaching of the present invention in an advantageous manner. To this aim, the present invention is described in more detail below; in particular, reference may be made to the claims dependent on claim 1 and on claim 14; further improvements, features and advantages of the present invention are explained below in more detail with reference to preferred embodiments by way of non-limiting example and to the accompanying drawings taken at least partly in connection with the following description of the embodiments, of which:

FIG. 1 illustrates a first embodiment of the present invention, working according to the method of the present invention;

FIG. 2 illustrates a second embodiment of the present invention, working according to the method of the present invention;

FIG. 3 illustrates a third embodiment of the present invention, working according to the method of the present invention;

FIG. 4 illustrates a fourth embodiment of the present invention, working according to the method of the present invention;

FIG. 5 illustrates a fifth embodiment of the present invention, working according to the method of the present invention; and

FIG. 6 illustrates a sixth embodiment of the present invention, working according to the method of the present invention.

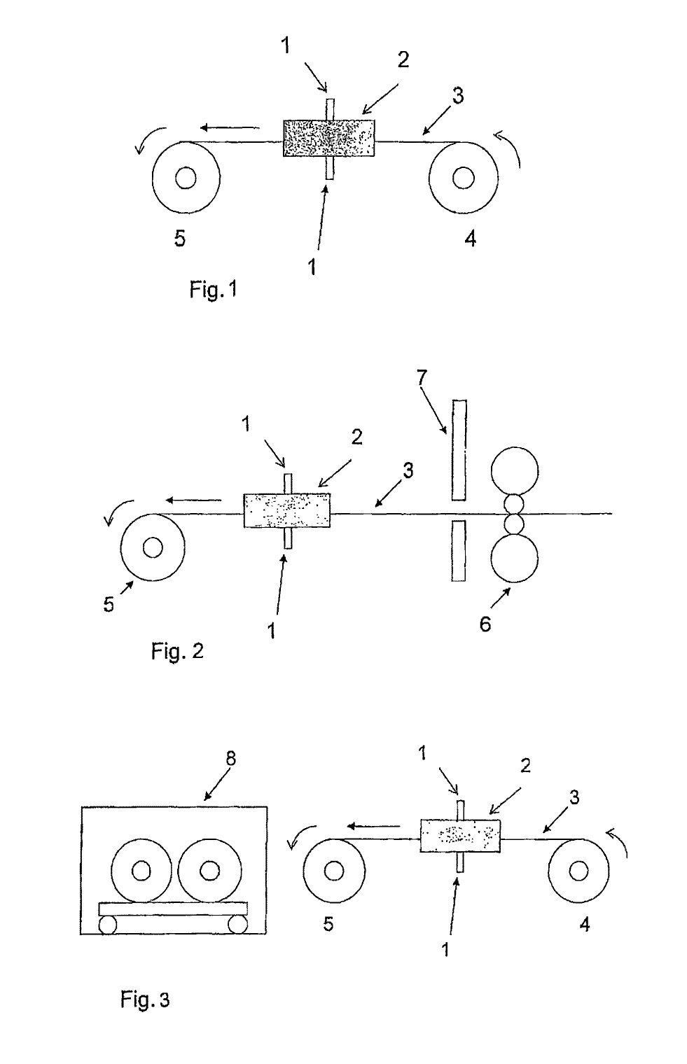

In the appended drawing figures, like equipment is labelled with the same reference numerals throughout the description of FIG. 1 to FIG. 6.

### DETAILED DESCRIPTION OF THE DRAWINGS; BEST WAY OF EMBODYING THE PRESENT INVENTION

FIG. 1 illustrates a first embodiment of the present method for annealing cold rolled aluminum strips 3.

According to the present invention a cold rolled strip 3 of aluminum is continuously transported along a transport path where a ramp 1 of direct flame impingement (DFI) burners are located, for heating the strip. According to this embodiment the cold rolled aluminum strip is unwound from a coil 4. Said ramp 1 is located perpendicular, or substantially perpendicular, to the direction of movement of the strip 3.

Further, the DFI burners 1 are mutually located such that the whole width of the strip is heated to the same, or substantially the same, temperature. The velocity of the strip 3 passing the said ramp 1 and the heating power of said burners are adapted to heat treat the strip 3 such that annealing of the strip is carried out and in that the heat treated strip is wound to a coil 5.

According to one embodiment of the present invention, the velocity of the strip 3 passing the said ramp 1 and the heating power of said burners are adapted to heat treat the strip 3 such that recrystallization of the strip 3 is carried out.

According to another preferred embodiment of the present invention there is at least one ramp 1 above and at least one ramp 1 below said transport path of said strip 3.

Experiments have been carried out with a cold rolled and coiled aluminum strip having a material thickness of 1 mm. The strip was passed one ramp of DFI burners located above the strip and one ramp of burners located below the strip. Each burner ramp had four burners.

The total power generated by the burners was 200 kW. At a strip speed passing the burners of 24 meters per second the temperature of the strip became 400° C. At a speed of thirty meters per second the temperature obtained was 365° C. No surface damages were observed.

It is deemed that the present invention is preferably used for strips having a thickness between 0.5 mm to a maximum thickness at which the strip can be coiled.

According to a preferred embodiment of the present invention there are two or more successive ramps 1 of DFI burners located after each other along the transportation path.

It is preferred that the ramp 1 or ramps are located in a furnace. However, in some applications the ramp or ramps can be mounted in a frame without a surrounding housing.

According to a second embodiment of the present invention a cold rolled aluminum strip 3 is lead directly from a rolling stand 6 to said transportation path, please see FIG. 2. According to this embodiment a safety wall 7 is located between the DFI furnace 2 and the rolling stand 6 because lubricants used when rolling may be flammable.

According to a third embodiment of the present invention, illustrated in FIG. 3, a heat treated and coiled strip 5 is placed in a soaking furnace 8 for partial annealing, i. e. for removal of dislocations. The soaking furnace 8 shall preferably be filled with nitrogen gas in order to minimize oxide growth.

In such case the soaking furnace 8 is kept at a temperature which corresponds to the temperature of the aluminum strip obtained by heating by said DFI burners. Thereby it is obtained that annealing of the coiled aluminum strip is started immediately in the soaking furnace throughout the whole coil.

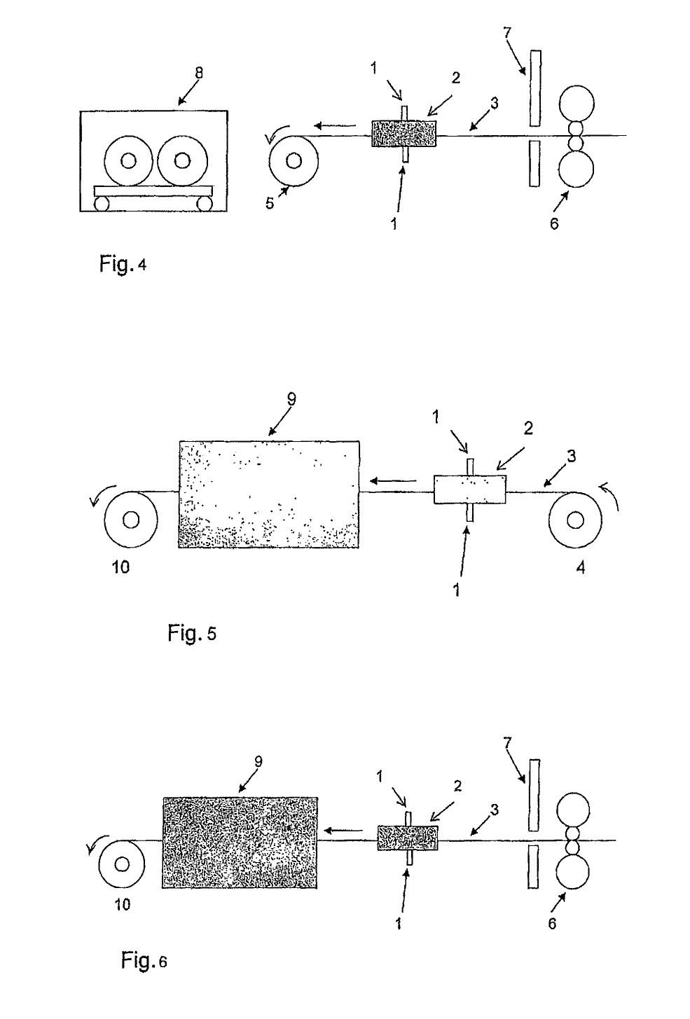

FIG. 4 illustrates that a cold rolled aluminum strip 3 is lead directly from a rolling stand to said transportation path, i. e, DFI furnace, whereafter it is coiled and placed in a soaking furnace.

FIG. 5 illustrates a fifth embodiment of the present invention, where a cold aluminum strip 3 is unwound from a coil 4, heat treated in the DFI furnace 2 and lead through a continuous soaking furnace 9, whereafter it is coiled 10.

FIG. 6 illustrates the embodiment illustrated in FIG. 5, but where the cold aluminum strip 3 is lead directly from a rolling stand 6 to said transportation path, i. e. DFI furnace 2, whereafter it is lead through a continuous soaking furnace 9, whereafter it is coiled 10.

The continuous soaking or annealing furnace is used to anneal cold rolled aluminum strips in order to provide aluminum sheet that can be easily formed and have relatively high strength and hardness, for example for use as automobile body components.

The continuous annealing furnaces are generally operated at temperatures of 450° C. to 600° C. At these temperatures the alloyed atoms are rendered into a state of solid solution at high temperatures above the solubility curve of the atom. This is followed by rapid quench to freeze the atoms in the aluminum structure. This process is known as solution heat treatment.

The time needed for the solution heat treatment process depends on what alloy is being treated and on the thickness of the strip. For example, solution heat treatment for a 0.5 mm to 0.9 mm thick strip is fifteen minutes if treated in a furnace providing heat transfer by hot air convection.

The time needed to heat the strip to the annealing process temperature depends on the efficiency of the furnace and the thickness of the strip being treated. A modern continuous furnace is capable of heating a 1 mm thick strip to a temperature of 540° C. in about one minute.

Modern metal treatment plants use the continuous annealing process in order to sufficiently anneal the strips and provide the desired strength and ductility. In order to heat the strip to the annealing temperature and to have adequate residence time to complete the annealing process, the annealing furnaces are required to be quite long, for example eighty meters in length. Higher production capacity requires even longer furnaces. These furnaces are therefore very high in cost.

Further, following the annealing process the annealed metal strip generally must undergo further surface finishing processes, including chemical cleaning to remove lubricants used in the cold rolling process.

According to the present invention, the strip to be annealed is pre-heated by DFI. This provides several advantages. One advantage is that the length of the annealing furnace can be significantly reduced. By pre-heating the strip using DFI it is possible to heat the strip from room temperature to annealing temperature (450° C. to 600° C.) in a few seconds or less.

In one test, an aluminum coil with a width of 200 mm, with a gauge of 0.25 mm, and running at a speed of ninety meters per minute was heated from 20° C. to 365° C. is one second. This very short heating time is significantly faster than the minute or more required to obtain the same heat up in the annealing furnace.

Therefore, by using the present invention, it is possible to reduce the length of the annealing furnace, essentially eliminating the length previously required for heating the strip to the annealing temperature. This reduces the capital equipment investment needed and lowers the cost of production.

Alternatively, since the annealing furnaces can operate at up to one hundred meters per minute, by pre-heating the strip using DFI according to the present invention, the speed of operation can be increased so that overall throughput for the annealing furnace can be significantly increased. This increases processing capacity and therefore lowers production costs.

A further advantage of the present invention is that post annealing chemical cleaning processes can be eliminated. The DFI heating of the strip burns away any lubricants and other impurities that may be present from the cold rolling process. Therefore, post annealing chemical cleaning is no longer necessary. This reduces capital equipment costs, improves productivity and lowers production costs.

While the present invention has been described primarily with respect to the processing of aluminum strips, the present invention is equally applicable to other metals, for example to copper, to iron, and to alloys of aluminum, of copper and/or of iron.

By the present invention all of the problems mentioned in the opening part are solved. Further, a very fast process is obtained since the strip is heated while it is unwound.

Above several embodiments of the present invention have been described. However, the present invention can be varied by the man skilled in the art without deviate from the inventive idea.

Thus, the present invention shall not be restricted to the embodiments described above, but can be varied within the scope of the attached claims.

### LIST OF REFERENCE NUMERALS

1 direct flame impingement (DFI) burner or ramp of direct flame impingement (DFI) burner(s)
2 furnace, in particular direct flame impingement (DFI) furnace
3 cold rolled metal strip
4 cold coil
5 coil or coiled strip
6 rolling stand
7 safety wall
8 soaking furnace or annealing furnace
9 soaking furnace or annealing furnace
10 coil or coiled strip

1. A method of preheating a cold rolled metal strip prior to continuous annealing, comprising:
continuously transporting the strip along a transport path where a ramp of direct flame impingement (DFI) burners are located for heating the strip, wherein the ramp is located perpendicular, or substantially perpendicular, to the direction of movement of the strip, wherein the DFI burners are located such that the whole width of the strip is heated to the same, or substantially the same, temperature, and wherein the velocity of the strip on the transport path passing the ramp and the heating power of the DFI burners are adapted to heat the strip to annealing temperature.

2. The method according to claim 1, wherein the ramp comprises at least one ramp above and at least one ramp below the transport path.

3. The method according to claim 1, wherein there are two or more successive ramps of DFI burners.

4. The method according to claim 1, wherein the DFI burners are located in a furnace, in particular in a direct flame impingement (DFI) furnace.

5. The method according to claim 1, wherein the strip is an unwound metal strip from a cold coil.

6. The method according to claim 1, wherein the strip is provided to the transportation path directly from a rolling stand.

7. The method according to claim 6, wherein a safety wall is located between the DFI burners and the rolling stand.

8. The method according to claim 1, wherein the strip is preheated to a temperature of between about 450° C. and about 600° C.

9. The method according to claim 1, wherein the strip is preheated in a few seconds or less.

10. The method according to claim 1, wherein the strip is an aluminum strip, a copper strip, an iron strip, or an alloy of aluminum, of copper and/or of iron.

11. The method according to claim 1, wherein the strip comprises a thickness between 0.5 mm to a maximum thickness at which the strip can be coiled.

12. The method according to claim 11, wherein the strip comprises a thickness of about 0.9 mm to about 1 mm.

13. A method of continuously annealing a cold rolled metal strip, comprising:
preheating the strip by;
continuously transporting the strip along a transport path where a ramp of direct flame impingement (DFI) burners are located for heating the strip, wherein the ramp is located perpendicular, or substantially perpendicular, to the direction of movement of the strip, wherein the DFI burners are located such that the whole width of the strip is heated to the same, or substantially the same, temperature, and wherein the velocity of the strip on the transport path passing the ramp and the heating power of the DFI burners are adapted to heat the strip to annealing temperature and
annealing the preheated strip in a continuous soaking furnace or annealing furnace.

14. The method according to claim 13, wherein the heat treated strip is wound to a coil.

15. The method according to claim 14, wherein the heat treated and coiled strip is placed in the soaking furnace for partial annealing and for removing dislocations.

16. The method according to claim 8, wherein the strip is preheated to a temperature of about 540° C.

17. The method according to claim 9, wherein the strip is preheated in about one second.
